(19) United States
(12) Patent Application Publication
(10) Pub. No.: US 2006/0253227 A1
(43) Pub. Date: Nov. 9, 2006

(54) Method for providing telematic services for vehicles

(75) Inventors: Thomas Ringel, Stuttgart (DE); Tim Schluesener, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/562,704

(22) PCT Filed: Jun. 23, 2004
(86) PCT No.: PCT/EP04/06771

§ 371 Date: Jun. 28, 2006

(30) Foreign Application Priority Data
Jun. 30, 2003 (DE) 103 29 521.6

(51) Int. Cl. G05D 1/00; G05D 3/00; G06F 17/00; G06F 7/00

(52) U.S. Cl. 701/2

(57) ABSTRACT

A method providing telematics services for vehicles, by which various aspects of services can be modified. The telematics services are in the form of configurable modules in the vehicle. Different modules can be activated and deactivated individually on the one hand by the customer or else via the service control center, in which case different access hierarchies can be provided. Inputting or editing of parameters for adaptation of the telematics services is carried out in conjunction with the service control center only by reconfiguration or configuration of service modules, and not by means of a software download. The method allows updating telematics services and are modifying to fit the customer throughout the entire life of the vehicle.

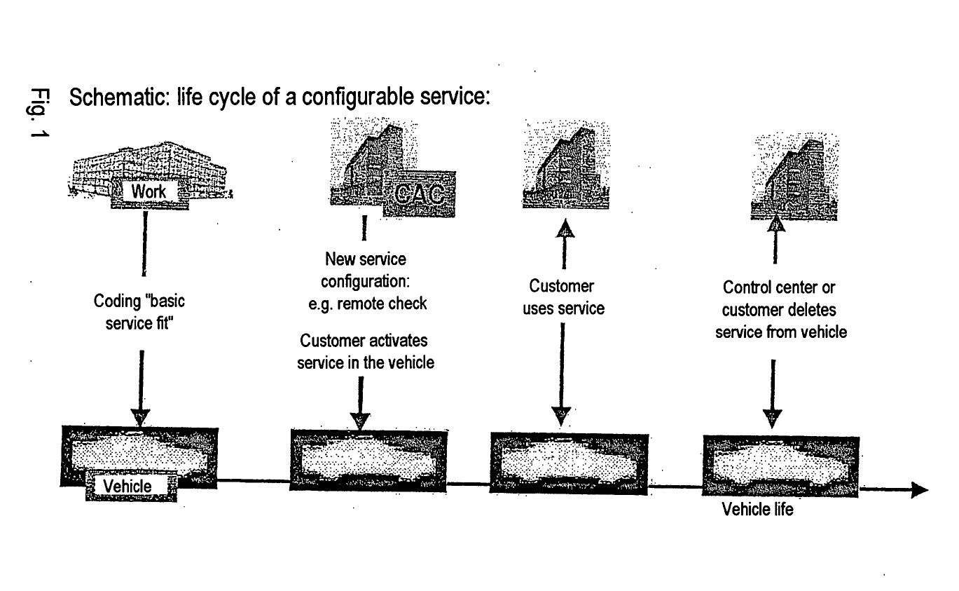

This application claims the priority of German Patent Application No. 103 295 521.6 filed Jun. 30, 2003, the disclosure of which is expressly incorporated by reference herein.

### BACKGROUND AND SUMMARY OF THE INVENTION

The invention relates to systems in the service area, which on the one hand ensure monitoring and diagnosis of various vehicle functions, while on the other hand also providing customer-specific services, for example a range of different information items.

Modern systems of this type integrate different functions such as these in telematics services, where, by way of example, remote diagnosis is provided for various technical components in the vehicle, breakdown assistance and status monitoring (constant monitoring) by interchanging data without the use of wires between a vehicle device in the customer vehicle (that is to say the vehicle of the customer of the telematics service) and a telematics control center. By way of example, DE 197 50 366 C2 and DE 198 16 575 A1 are cited in this context.

Every telematics service is programmed individually at the time, and is permanently stored in the controllers that are fitted to the vehicle during its production. The various process procedures for telematics services thus normally run on the basis of a fixed scheme in the vehicle, and no provision is made for flexible editing during the vehicle life cycle. However, this fixed scheme is not always sensible. For example, depending on the actual version of the customer requirement, a telematics service may include, or need not include, a voice call to the telematics control center.

The services in the vehicle are normally defined more than two years before market introduction. The service definitions may thus later become obsolescent in some cases as a result of the rapid development in the telematics world. Retrospective adaptation or upgrading of the services that have been implemented ex-works to provide further-developed application options is feasible only by reprogramming the control system. A corresponding situation applies to the integration of entirely newly developed telematics techniques during the life of a vehicle.

The invention is based on telematics service systems for vehicles with the stated restrictions relating to the fixing of the process procedures. One object of the present invention is to develop a method for telematics service systems which largely overcomes the stated disadvantages.

### BRIEF DESCRIPTION OF THE DRAWING

The sole feature illustrates an example of a reconfiguration of a telematic service.

### DETAILED DESCRIPTION OF THE INVENTION

The fundamental idea of the invention is that telematics control elements are configured and can be modified individually in that vehicle for which the telematics services are provided by interchanging data without the use of wires between a stationary service control center and the vehicle, as modules which can be executed autonomously for different telematics service functions. In other words, the individual telematics service procedures which until now have been stored in a fixed form in the vehicle (for example data transmission, voice call, SMS despatch, event for initiation etc.) are subdivided into individual “service modules” and are fitted to the controller as modules. In consequence, these modules can be combined variably as required for an adapted profile of the telematics service.

According to the invention, different levels of configuration capability are provided: first of all, the customer can himself integrate or remove specific services in or from the telematics service system, for example by selection using a soft key, so that an optimally matched telematics menu is available at the user end. Modules which form functional groups since, for example, they are thematically associated, or which cooperate with one another by interchanging data can in this case be combined in a simple manner to form appropriate functional groups.

If the customer requirements change, then the customer can himself create individual reconfigurations at any time. The combination of the modules may also be modified, of course, in an appropriate manner from the service control center after contact is made with it, or else while stationary during a maintenance process.

Specific telematics services, for example monitoring of the basic vehicle functionality, breakdown assistance and the like, which are therefore of critical importance, are not available for direct access by the customer in order to preclude accidental “deletion” of these essential services. According to the invention, however, these modules may on the other hand be reconfigured by the service control center or by maintenance personnel by means of appropriate enable codes.

“Service modules” whose function depends on appropriate parameters (for example relating to data selection, destination telephone number, threshold values, etc.) can, according to the invention, also be modified with respect to these parameters. An access hierarchy is provided in this case as well, in order that important functions cannot be interfered with by accidentally entering incorrect data. The configuration process may in this case also relate to control functions for effective interaction between the modules.

In the case of the method according to the invention, the inputting or editing of telematics services in the vehicle is carried out only by the configuration of “service modules”, that is to say not by means of a software download. This means that there is no need to take into account the safety and security requirements which would otherwise normally be required for a software transfer, in this method.

It is advantageously proposed that dynamic control elements which are associated with the telematics control elements be configured as a function of the modification of the modules. Operation is thus always automatically matched to the current, up to date configuration of the modules. By way of example, soft keys (for example parts of a touch-sensitive display) represent one suitable embodiment of dynamic control elements such as these.

By way of example, the figure shows the capability to reconfigure a telematics service. A vehicle is first of all provided ex-works with a “basic service fit” with a restricted functional scope. Subsequent addition of an additional service (in this case: “remote check”) is implemented by inputting the appropriate module parameters via the service control center (CAC, Customer Assistance Center). The customer activates this new service in his vehicle by recording it in his individually configured telematics service menu. This service function is available immediately to the customer, without any restriction. If the customer no longer desires this service, then this “service module” can be deactivated again either by the customer himself (deletion from his menu selection) or via the service control center.

The method according to the invention has various advantages over a telematics service with a rigidly predetermined range of services:
Telematics services can even be activated retrospectively in relatively old vehicles.
The telematics services can always be kept up to date throughout the entire life of the vehicle.
Every customer can individually optimize his telematics service system to his personal requirements.
Modifications are implemented without any software download.
Critical modules and parameters are protected against unintentional intervention by a staggered access hierarchy.

The method according to the invention for configuration of telematics services makes an important contribution to continuous optimization of the functions supported in a vehicle throughout the entire life of the vehicle. In addition to an increase in convenience, this is also associated with a considerable improvement in terms of safety aspects.

1. A method for providing improved telematics services for vehicles, wherein data is interchanged without the use of wires between a stationary service control center and a plurality of telematics control elements in the vehicle, comprising the step:
at least one of configuring said control elements and individually modifying each of said control elements using at least one of said data interchanging and vehicle user input which can be executed autonomously for different telematics service functions.

2. The method as claimed in claim 1, wherein a module can be modified not only by the user in the vehicle but also by the stationary service control center.

3. The method as claimed in claim 1, wherein the modules are classified on the basis of relevance criteria, with the classification being linked to a restriction to the capability to modify the modules.

4. The method as claimed in claim 3, wherein the relevance criteria relate to driving safety, and safety-relevant modules can be modified only by the stationary service control center.

5. The method as claimed in claim 1, wherein,
the modification of the modules also includes at least one of activation and deactivation.

6. The method as claimed in claim 1, wherein
the modification of a module also includes the inputting, editing or deletion of function parameters.

7. The method as claimed in claim 6, wherein that function parameters of individual modules can be modified only by the stationary service control center.

8. The method as claimed in claim 1, wherein,
that modules which interact in terms of at least one of content technical data exchange are combined to form functional groups.

9. The method as claimed in claim 1, wherein,
dynamic control elements which are associated with the telematics control elements are configured as a function of the modification of the modules.

10. The method as claimed in claim 9, wherein the dynamic control elements are in the form of soft keys.

11. The method as claimed in claim 2, wherein the modules are classified on the basis of relevance criteria, with the classification being linked to a restriction to the capability to modify the modules.

12. The method as claimed in claim 2, wherein the modification of the modules also includes at least one of activation and deactivation.

13. The method as claimed in claim 3, wherein the modification of the modules also includes at least one of activation and deactivation.

14. The method as claimed in claim 2, wherein the modification of a module also includes the inputting, editing or deletion of function parameters.

15. The method as claimed in claim 3, wherein the modification of a module also includes the inputting, editing or deletion of function parameters.

16. The method as claimed in claim 2, wherein modules which interact in terms of at least one of content technical data_exchange are combined to form functional groups.

17. The method as claimed in claim 3, wherein modules which interact in terms of at least one of content technical data exchange are combined to form functional groups.

18. The method as claimed in claim 2, wherein dynamic control elements which are associated with the telematics control elements are configured as a function of the modification of the modules.

19. The method as claimed in claim 3, wherein dynamic control elements which are associated with the telematics control elements are configured as a function of the modification of the modules.
